(19) United States
(12) Patent Application Publication
(10) Pub. No.: US 2026/0156000 A1
(43) Pub. Date: Jun. 4, 2026

(54) CASE FOR MOBILE COMPUTING DEVICES WITH INDEPENDENT PROCESSOR AND USER INTERFACE WITH DATA PROTOCOL STACK

(71) Applicant: Drumwave, Inc., Palo Alto, CA (US)

(72) Inventors: André Vellozo, Palo Alto, CA (US); Javier Cruz, Santos (BR); Alberto Cruz, São Paulo (BR)

(21) Appl. No.: 19/405,025

(22) Filed: Dec. 1, 2025

Related U.S. Application Data
(60) Provisional application No. 63/726,493, filed on Nov. 30, 2024.
(60) Provisional application No. 63/886,990, filed on Sep. 24, 2025.

(51) Int. Cl. H04L 9/32

(52) U.S. Cl. CPC H04L 9/3263

(57) ABSTRACT

Systems and methods are disclosed for generating and governing standardized datasets using a Value Schema System (VSS). The VSS receives event data records from one or more data sources and generates common data schemas (CDSs) referencing standardized vocabularies and dictionaries. Based on the CDSs, the VSS constructs transactional data schemas (TDSs), issues data certificates identifying data owners, and associates certified event data with the data certificates. The VSS generates schema-compliant datasets structured according to the TDSs and stores the datasets in a data store for interoperable use. When a computing system requests access to a dataset, the VSS retrieves the corresponding data certificate, verifies ownership-based access conditions, determines dataset conformance to the TDS, and, upon successful verification, provides authorized access and enables cross-system use. In some embodiments, event data records may be generated by a mobile computing case having an independent processor.

### CROSS-REFERENCE TO RELATED APPLICATIONS

This application claims the benefit of U.S. Provisional Patent Application No. 63/726,493, filed Nov. 30, 2024, and U.S. Provisional Patent Application No. 63/886,990, filed Sep. 24, 2025, the entire contents of each of which are hereby incorporated by reference in their entireties.

### BACKGROUND

### 1. Field

The present disclosure relates generally to computer systems and, more specifically, to a decoupling data transactions through an independent processing and verification framework.

### 2. Description of the Related Art

The rapid digitalization of industries has led to the emergence of the data economy, where data serves as a fundamental asset for innovation, decision-making, and economic growth. Businesses, governments, and individuals generate vast amounts of structured and unstructured data, which, when effectively processed and analyzed, can drive new business models and enhance operational efficiencies. The proliferation of cloud computing, artificial intelligence, and blockchain technologies has further accelerated data monetization, enabling companies to extract value through data-driven services, personalized recommendations, and predictive analytics. However, as the data economy expands, concerns over data privacy, security, regulatory compliance, and transparency have become critical challenges, necessitating robust frameworks for data governance and fair value exchange.

### SUMMARY

The following is a non-exhaustive listing of some aspects of the present techniques. These and other aspects are described in the following disclosure.

In some aspects, the techniques described herein relate to a method including: receiving, by a Value Schema System (VSS), an event data record generated by a mobile computing case having an independent processor, the event data record including information characterizing an event performed by a user authenticated through the mobile computing case; generating, by the VSS and based on observed data-generating activities including the event data record, a plurality of common data schemas, each common data schema defining standardized data attributes according to one or more standard vocabularies and one or more standard dictionaries; selecting, by the VSS, a first common data schema of the plurality of common data schemas in response to the first common data schema satisfying a common data schema condition; generating, by the VSS, a transactional data schema based on the first common data schema and in accordance with a transactional data schema condition; issuing, by the VSS, a data certificate conforming to the transactional data schema and identifying a data owner associated with the event data record; associating, by the VSS, the event data record with the data certificate; generating, by the VSS, a schema-compliant dataset including a pointer to a storage location of the event data record, a data certificate identifier of the data certificate, and a transactional data schema identifier of the transactional data schema; and storing, by the VSS, the schema-compliant dataset in a data store and making the schema-compliant dataset available for access by one or more computing systems.

In some aspects, the techniques described herein relate to a method including: receiving, by a Value Schema System (VSS), an event data record generated by one or more data sources; generating, by the VSS based on the event data record, a plurality of common data schemas, each common data schema referencing one or more standard vocabularies and one or more standard dictionaries; selecting, by the VSS, a first common data schema of the plurality of common data schemas in response to the first common data schema satisfying a common data schema condition; generating, by the VSS, a transactional data schema mapped to the first common data schema; issuing, by the VSS, a data certificate based on the transactional data schema and identifying a data owner; associating, by the VSS, the event data record with the data certificate; generating, by the VSS, a schema-compliant dataset including a structured representation of the event data record according to the transactional data schema; and storing, by the VSS, the schema-compliant dataset in a data store and making the schema-compliant dataset available for access by one or more computing systems.

In some aspects, the techniques described herein relate to a method including: receiving, by a Value Schema System (VSS), a request from a computing system to access a schema-compliant dataset stored in a data store, the request identifying a dataset identifier; retrieving, by the VSS, a data certificate associated with the dataset identifier, the data certificate referencing a transactional data schema defining attribute constraints for data within the schema-compliant dataset; verifying, by the VSS and based on the data certificate, that the computing system satisfies one or more access conditions associated with a data owner identified in the data certificate; determining, by the VSS and based on the transactional data schema, that the schema-compliant dataset conforms to attribute constraints defined by the transactional data schema; in response to verifying the one or more access conditions and determining that the schema-compliant dataset conforms to the transactional data schema, providing, by the VSS, at least a portion of the schema-compliant dataset to the computing system through an interface of the VSS; and enabling, by the VSS, cross-system use of the schema-compliant dataset by permitting the computing system to reference the dataset identifier and associated data certificate in subsequent requests submitted by additional computing systems.

In some aspects, the techniques described herein relate to a method of generating a data schema for data, including: generating, by a computer system, a plurality of common data schemas, wherein each common data schema is based on observed data activities; generating, by the computer system, a transactional data schema based on a first common data schema of the plurality of common data schemas, wherein the first common data schema is selected in response to satisfying a common data schema condition; issuing, by the computer system, a data certificate based on the transactional data schema, wherein the issuing the data certificate is in response to the transactional data schema satisfying a transactional data schema condition; associating, by the computer system, data with the data certificate; and storing, by the computer system, the data and the data certificate that is associated with the data in storage.

In some aspects, the techniques described herein relate to a tangible, non-transitory, machine-readable medium storing instructions that when executed by a data processing apparatus cause the data processing apparatus to perform operations including: generating, by a computer system, a plurality of common data schemas, wherein each common data schema is based on observed data activities; generating, by the computer system, a transactional data schema based on a first common data schema of the plurality of common data schemas, wherein the first common data schema is selected in response to satisfying a common data schema condition; issuing, by the computer system, a data certificate based on the transactional data schema, wherein the issuing the data certificate is in response to the transactional data schema satisfying a transactional data schema condition; associating, by the computer system, data with the data certificate; and storing, by the computer system, the data and the data certificate that is associated with the data in storage.

In some aspects, the techniques described herein relate to a smart case for a mobile computing device, including: a protective housing configured to receive and secure the mobile computing device; an independent processor; a memory storing executable instructions that, when executed by the independent processor, perform operations for secure data capture, encryption, and selective disclosure according to user-defined conditions; one or more biometric sensors configured to authenticate a user; a display interface for user interaction; and a communication interface configured to exchange data with a Value Schema System (VSS) without requiring access to the mobile computing device's native operating system, wherein the smart case is adapted to initiate, control, and locally process data transactions associated with generation of Common Data Schemas (CDS), registration of Transactional Data Schemas (TDS), and issuance of Data Certificates (DC).

In some aspects, the techniques described herein relate to a data transaction control device including: a housing configured to receive, attach to, or be worn in association with a mobile computing device; an independent processor; a memory storing executable instructions that, when executed by the independent processor, perform operations for secure data capture, encryption, and selective disclosure according to user-defined conditions; one or more user authentication components; a display interface; and a communication interface configured to exchange data with a Value Schema System (VSS) without requiring access to the mobile computing device's native operating system, wherein the device is adapted to initiate, control, and locally process data transactions associated with generation of Common Data Schemas (CDS), registration of Transactional Data Schemas (TDS), and issuance of Data Certificates (DC).

In some aspects, the techniques described herein relate to a global interoperability protocol for a Value Schema System (VSS), the protocol including: a hierarchical naming structure configured to generate globally unique identifiers for core objects of the VSS, including Common Data Schemas (CDS), Transactional Data Schemas (TDS), Data Certificates (DC), and Business Ready Datasets (BRD); locator elements embedded in the identifiers specifying region, country, data provider, data custodian, and data owner; and governance rules that enforce data sovereignty and provenance compliance based on the embedded locator elements, wherein the protocol enables consistent semantic interpretation, traceability, and interoperability of data transactions across distributed systems.

In some aspects, the techniques described herein relate to a computer-implemented method for automated registration and certification of data within a Value Schema System (VSS), including: observing data-generating activities; determining, based on a common data schema policy, whether a new Common Data Schema (CDS) is required; generating and registering the CDS in a global value schema registry; receiving, from a data provider, a request to register a Transactional Data Schema (TDS) mapped to the CDS; issuing, upon execution of a Shared Custody Agreement (SCA) between the data provider and a data owner, a Data Certificate (DC) conforming to the TDS; and automatically incorporating data generated under the DC into a Business Ready Dataset (BRD) in accordance with the TDS schema specification.

Unlike conventional digital wallets, personal data management applications, or blockchain-based certification systems, the present techniques integrate a dedicated hardware device—a smart case with an independent processor, biometric interface, and secure local storage—with a multi-layer Value Schema System (VSS) capable of real-time, user-controlled unbundling of data transactions from economic exchanges. Existing solutions typically rely solely on software running within the mobile device's native operating system or on remote cloud services, exposing the data flow to latency, centralized control, and potential compromise. In contrast, the disclosed system performs pre-processing, encryption, selective disclosure, and schema mapping directly at the hardware level, before data leaves the user's physical control, and then propagates it into a standardized, certificate-based framework for ownership validation and monetization. This physical-digital coupling, together with the hierarchical Naming Protocol and schema-based governance model, provides a level of sovereignty enforcement, interoperability, and value attribution not found in prior art.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1A is a perspective view of a smart case for a mobile computing device, in accordance with some embodiments of the present disclosure;

FIG. 1B is another view of the smart case of FIG. 1A, in accordance with some embodiments of the present disclosure;

FIG. 1C is a block diagram of the mobile computing device and the smart case, in accordance with some embodiments of the present disclosure;

FIG. 1D is a block diagram of a computing environment including a value schema system (VSS), in accordance with some embodiments of the present disclosure;

FIG. 2 illustrates a VSS with core object associations, in accordance with some embodiments of the present disclosure;

FIG. 3 illustrates a workflow associated with a system operator for registering and managing common data schemas within the VSS, in accordance with some embodiments of the present disclosure;

FIG. 4 illustrates relationships between participants, modules, and objects within the VSS, in accordance with some embodiments of the present disclosure;

FIG. 5 illustrates a hierarchical naming protocol for generating unique identifiers for core objects within the VSS, in accordance with some embodiments of the present disclosure;

FIG. 6 illustrates a flowchart of an example method for generating a schema-compliant dataset within the VSS, in accordance with some embodiments of the present disclosure;

FIG. 7 illustrates a flowchart of an example method for governing access to a schema-compliant dataset within the VSS, in accordance with some embodiments of the present disclosure; and

FIG. 8 is an example of a computing device upon which the present techniques may be implemented, in accordance with some embodiments of the present disclosure.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of computer science. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these

### Acronyms

VSS refers to the Value Schema System, which may be a multi-layer framework for standardizing, certifying, and organizing data to ensure interoperability, sovereignty, and value attribution.

CDS refers to a Common Data Schema, which may be a standardized data model created by the system operator for consistent definitions across different domains.

TDS refers to a Transactional Data Schema, which may be an extension of a CDS that adds contextual and ownership details for specific transactions.

DC refers to a Data Certificate, which may be a digital record of shared custody and ownership based on a registered TDS.

BRD refers to a Business Ready Dataset, which may be a certified and structured dataset that conforms to a TDS and is suitable for downstream use.

SCA refers to a Shared Custody Agreement, which may be a contract defining shared data custody, usage rights, and terms governing interactions among parties contributing or controlling data.

DO refers to a Data Origin, which may be the source location of raw data before certification.

NP refers to a Naming Protocol, which may be a hierarchical identification protocol that embeds provenance and jurisdictional information for objects in the system.

OWL refers to the Web Ontology Language, which may be a knowledge-representation standard for defining ontologies and semantic relationships.

ETL refers to Extract, Transform, Load operations, which may be processes used to prepare data for compliance with VSS standards.

A central difficulty in modern distributed computing environments arises from the lack of mechanisms to structure, classify, and contextualize data at the moment the data is generated. Conventional computing devices often embed transaction-related or interaction-related data implicitly within broader application workflows, making it difficult for downstream systems to discern provenance, meaning, or custodial relationships. These devices typically lack a unified or standardized way to apply consistent semantic definitions across domains, resulting in data ambiguity, data redundancy, and inconsistent interpretations across independent systems.

Furthermore, existing computing systems may be unable to reliably attach metadata, such as ownership information, jurisdictional constraints, custodial relationships, or semantic definitions, to data objects at the time of creation. Without such metadata, distributed systems cannot determine the context in which data should be processed, the permissions associated with the data, or the structural requirements for utilizing the data in computational operations. As a result, systems experience failures in interoperability, inconsistent data transformations, and difficulties in automating processes that rely on accurate data lineage.

Conventional mobile devices may also be inadequate for capturing or structuring data at the moment of generation. For example, unlocking a mobile device, navigating to an application, or entering information manually may impose friction that discourages users from providing relevant contextual data. At the same time, bypassing security restrictions on such devices may be infeasible or undesirable due to risks associated with privileged access, untrusted software layers, and exposure of sensitive information. These constraints limit the extent to which existing mobile devices can participate in secure, low-latency data structuring workflows.

Challenges also arise in organizing data technology itself. Current systems often lack standardized governance protocols, real-time certification mechanisms, and structured pathways for transforming raw data into technically enforceable objects aligned with semantic rules. Without uniform data schemas, automated systems struggle to determine the intended meaning of data, the applicable contextual requirements, or the appropriate integration pathways across heterogeneous computing environments.

Embodiments of the present disclosure address these challenges by introducing a Value Schema System (VSS) that may implement a multi-layer data protocol stack for classifying, certifying, and structuring data in real time. The VSS may generate and maintain Common Data Schemas (CDS), Transactional Data Schemas (TDS), and Data Certificates (DCs), each embedding standardized vocabularies, semantic definitions, and provenance information. By enforcing these structures, the VSS may provide a consistent and interoperable mechanism for transforming raw data into structured, machine-actionable objects that downstream systems can process deterministically.

The VSS may further include modules for schema registration, schema lookup, certificate issuance, ETL processing, and generation of structured datasets. These modules may ensure that data originating from disparate devices or applications can be classified in a uniform manner, validated for conformance with schema definitions, and associated with jurisdictional or custodial metadata. The inclusion of a hierarchical Naming Protocol (NP) may allow identifiers to embed region, custodian, provider, and ownership information, thereby enabling deterministic routing, lookup, traceability, and validation operations that conventional identifiers cannot reliably support.

In some embodiments, a mobile computing case having an independent processor may serve as a trusted hardware component for capturing and structuring data at the moment of origin. The mobile computing case may authenticate a user through a biometric sensor, generate a structured or partially structured data record, perform cryptographic signing, and convey the data record to the VSS without requiring privileged access to an operating system of a mobile device received in the case. By performing these operations, the mobile computing case may reduce reliance on untrusted software layers, lower the latency associated with data capture workflows, and enhance the fidelity and trustworthiness of the data provided to the VSS.

From a technical standpoint, the disclosed systems may improve the functioning of computer systems by reducing schema mismatches, resolving semantic ambiguities in distributed processing environments, and enabling more efficient and reliable routing and classification of data. The VSS may transform raw, heterogeneous inputs into structured objects at the moment of creation, thereby eliminating the need for retrospective reconciliation steps that frequently introduce errors or inconsistencies. The use of a hardware-originated, authenticated data record may further enhance security by ensuring that downstream systems can validate the integrity, provenance, and contextual correctness of the data.

Embodiments of the present disclosure therefore provide a technical solution to the shortcomings identified above by integrating a trusted edge-computing device with a schema-governed, certificate-driven data classification framework. This combination may facilitate secure, real-time, and interoperable data structuring operations across distributed systems, enhancing the reliability, consistency, and technical performance of data processing workflows within digital trust ecosystems.

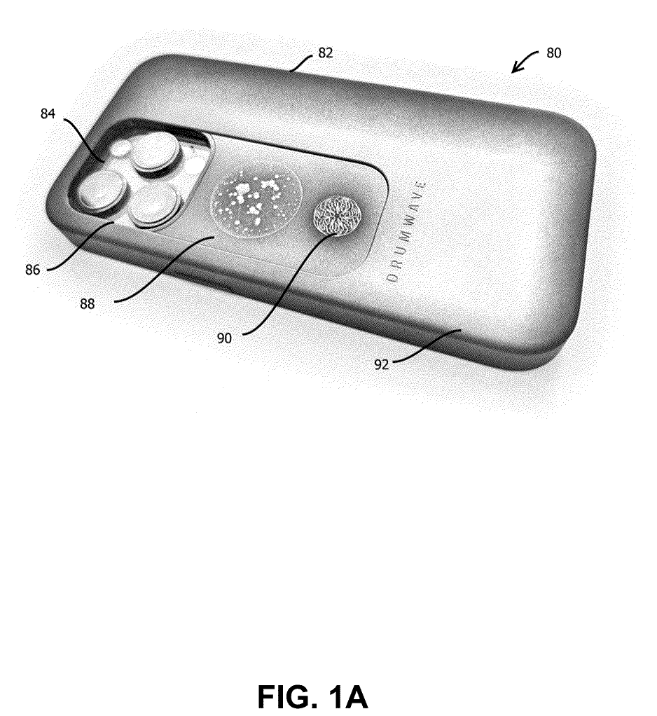

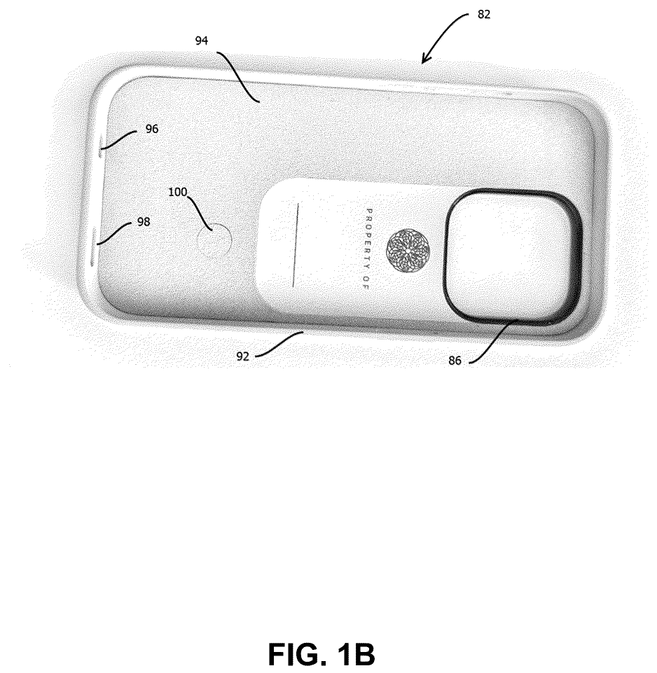

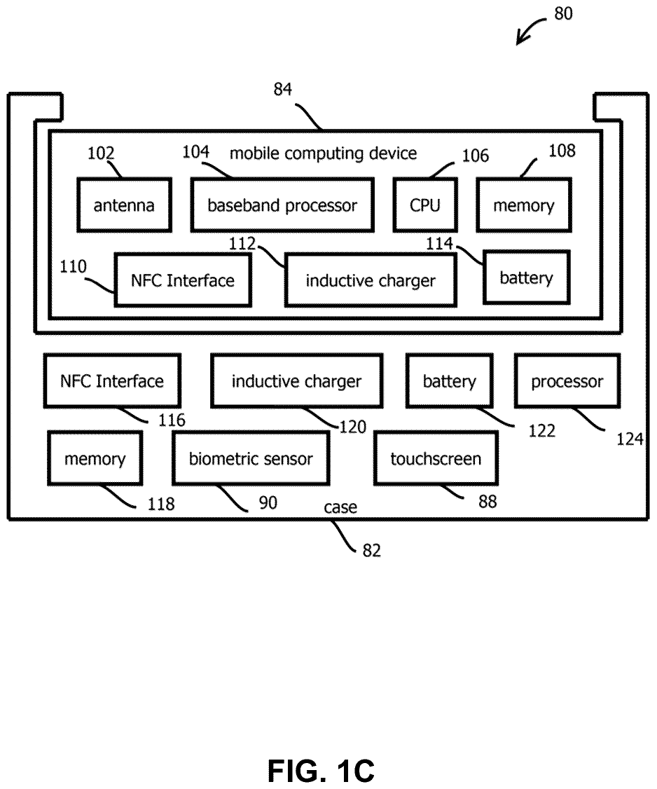

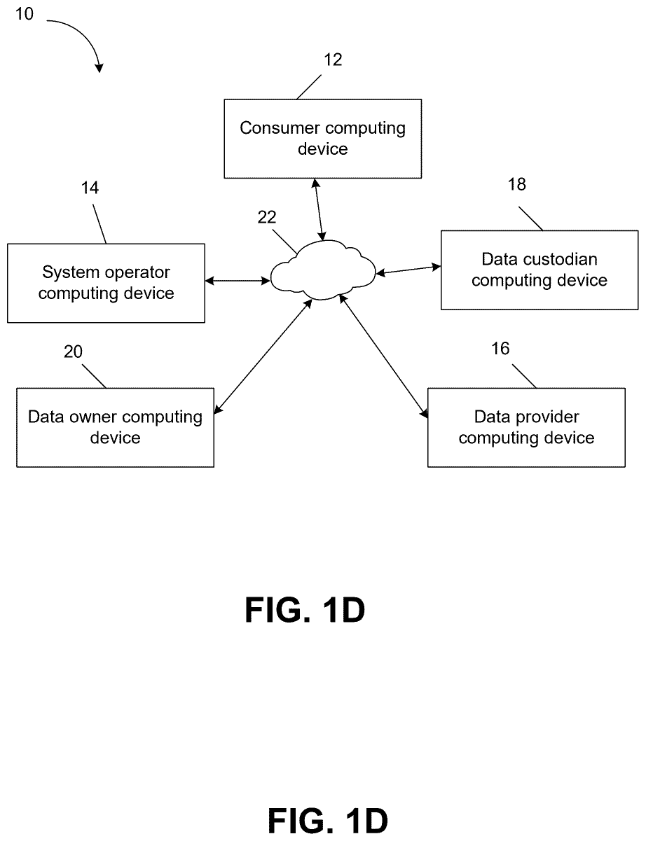

Some embodiments may mitigate these issues with an assembly 80, like that shown in FIG. 1A, which includes a smart case 82, like a data wallet, for a mobile computing device 84, such as a cell phone. In some cases, the smart case 82 may include an aperture 86 for the cameras of the computing device 84, a touchscreen 88, a biometric sensor 90, and a protective case 92 that at least partially envelops the mobile computing device 84 to protect it from falls. The smart case 82 may additionally generate event data records characterizing user-initiated actions or device events, which may be authenticated or formatted at the edge for use by a value schema system (VSS).

In some embodiments, the touchscreen 88 is a capacitive touchscreen with a backlit light-emitting diode display, an organic light-emitting diode display, a transflective display, an electronic ink display, or the like. In some cases, the display is black and white, and in other cases, the display may be in color. In some embodiments, the biometric sensor 90 is a fingerprint sensor, though various other types of biometric sensors may be used, including retinal sensors, voice sensors, and the like. The touchscreen 88 may be used to capture contextual user input associated with an event, which may be incorporated into the event data records.

In some embodiments, the case 92 may be made from materials that include thermoplastic polymers, elastomers, metals, natural materials, or composite materials. Thermoplastic polymers, such as polycarbonate or acrylonitrile butadiene styrene (ABS), may be molded to form a rigid protective shell that offers impact resistance. Elastomers, including thermoplastic polyurethane (TPU) or silicone rubber, may provide flexibility and shock absorption, allowing for impact mitigation in case of drops. Metals such as aluminum or titanium may be incorporated in some embodiments for durability and a premium aesthetic, though metal may impact signal transmission and may involve design considerations such as antenna windows.

In other embodiments, natural materials such as wood, leather, or cork may be used to offer aesthetic variety and may be bonded to or combined with synthetic materials to enhance protective characteristics. Composite materials, which may combine features of multiple base materials, may also be employed. For example, carbon fiber composites may be used in some embodiments to provide a lightweight yet strong case structure. Some cases may include additional coatings or treatments, such as hydrophobic coatings to resist moisture ingress or oleophobic coatings to reduce smudging.

FIG. 1B shows the other side of the smart case 82 with the mobile computing device (e.g., cell phone) removed. As illustrated, the sidewalls of the case 92 may envelop the sides of a mobile computing device. In some embodiments, the smart case 82 includes a backplate 94, for instance, made of a relatively soft, resilient material like felt covering a layer of plastic, to protect electronics, as described below with reference to FIG. 1C. In some embodiments, the smart case 82 includes various apertures 96 and 98 to charge the mobile computing device and allow audio to escape through speakers. In some embodiments, the smart case 82 includes an internal button 100 to turn the case on or off. It is expected that users will leave the smart case 82 on most of the time to provide a relatively low-effort, simple way to capture and transmit event data as described below.

FIG. 1C is a block diagram of the assembly 80, including the mobile computing device 84 and the smart case 82. As illustrated, the mobile computing device may include an antenna 102, a baseband processor 104, a CPU 106, memory 108, a near-field communication (NFC) interface 110, an inductive charger interface 112, and a battery 114. In some embodiments, the smart case 82 may include an NFC interface 116, memory 118, an inductive charger interface 120, the biometric sensor 90, the touchscreen 88, a battery 122, and a processor 124. The processor 124 may operate independently of the CPU 106, enabling the smart case 82 to generate authenticated event data records without requiring access to an operating system of the mobile computing device 84.

In operation, in some embodiments, the smart case 82 may communicate with an application executing on the CPU 106 and stored in memory 108 of the mobile computing device 84 via the NFC interfaces 110 and 116. Alternatively, some embodiments may communicate via other wired or wireless interfaces, such as Wi-Fi™, Bluetooth™, infrared communication, and the like. In some embodiments, the battery 114 of the mobile computing device 84 may be charged via inductive charging through the inductive charger interface 112 and the inductive charger interface 120, drawing from the battery 122 of the smart case 82. In some cases, the flow of energy may be in the opposite direction. In some embodiments, communications from the smart case 82 may include event data records containing metadata such as timestamps, device identifiers, region identifiers, biometric-authentication indicators, or contextual inputs captured by the touchscreen 88. Such metadata may be used by a VSS to determine schema selection, generate transactional data schemas, or issue data certificates.

In operation, the smart case 82 may be used to execute user-authenticated events by accessing credentials in a secure enclave of the case 82 to effectuate interactions with an external device, terminal, or service. In some embodiments, engaging in such an event may cause a user interface, like that described in U.S. Prov. Pat. App. 63/712,444 (having docket no. 043638-0581481), titled CASE FOR MOBILE COMPUTING DEVICES WITH INDEPENDENT PROCESSOR AND USER INTERFACE FOR AUGMENTING LABELS LINKED TO PRODUCTS and U.S. application Ser. No. 19/370,247 (having docket no. 043638-0586629), titled CASE FOR MOBILE COMPUTING DEVICES WITH INDEPENDENT PROCESSOR AND USER INTERFACE FOR AUGMENTING LABELS LINKED TO PRODUCTS, which are each hereby incorporated by reference in their entireties, to appear, e.g., without the user unlocking their mobile computing device and without using credentials stored on the mobile computing device. Execution of such an authenticated event may cause the smart case 82 to generate an event data record describing the event, which may be transmitted to a VSS for use in event provenance tracking, schema generation, or certificate issuance. In some embodiments, the case may also include an inertial measurement unit operative to sense whether the case is facing down or up. In some embodiments, in response to detecting that the phone is placed face down, the smart case 82 may instruct the mobile computing device 84 to disable microphones and cameras to enhance the user's privacy. In some embodiments, the smart case 82 may be used in conjunction with a value schema system to generate or consume data, perform data standardization, verify or establish ownership, verify or establish sovereignty, and ensure interoperability in digital trust ecosystems.

The hardware above may be used to supply or access data like that described below. It should be emphasized, though, that the techniques below may be implemented without using the hardware above, and the hardware above may be used in systems other than those described below, which is not to suggest that any other feature herein is limiting. When used with a VSS, the smart case 82 may provide a hardware-trusted boundary for capturing, authenticating, and transmitting event data prior to processing by distributed computing systems.

Some embodiments afford a form of dynamic entitlement, where the utility, access conditions, or permissible use of data may change based on factors such as location, system state, or individual behaviors. Some embodiments offer features well beyond those of a simple QR code (though QR codes may be used as part of these approaches), which generally only offer one-way data sharing, by incorporating intent and meaning into an event itself. Some embodiments implement a computing infrastructure that facilitates contextual use of data, enhancing user experience while enabling rich data characterization.

In some embodiments, data custody is different from data ownership. In some embodiments, a party to an event that generates data may have an ownership stake in data characterizing that relationship, even though another party stores or maintains custody of that data. In some cases, entities may also have defined rights to use data generated in such events, subject to shared-custody arrangements or other access-control rules. The forms of standardization described here are expected to reduce friction when entities access data in the custody of other entities, among other benefits. In some embodiments, the data schema is referred to as a value schema system. Embodiments of the value schema system are discussed in more detail below.

As discussed above, traditional data management systems struggle with several critical issues. For example, data management systems may lack standardization. Diverse data sources use different formats and terminologies, making it challenging to integrate and utilize data effectively. Furthermore, data management systems may provide inadequate data ownership. Existing systems do not adequately track or enforce data ownership, leading to disputes and uncertainties about data provenance and control. Another issue with data management systems includes poor interoperability. Data management systems often cannot communicate or share data seamlessly, hindering collaboration and data-driven decision-making. Compliance and sovereignty may be another issue with data management system. Ensuring data compliance with regional and international regulations is complex and often insufficiently addressed by data management systems. In addition, many systems fail to properly assess and assign value to data, leaving companies unable to fully leverage it as a strategic asset. This undervaluation hampers the ability to optimize data-driven insights and distribute value fairly across stakeholders.

These challenges demand a new approach to data management that places ownership, standardization, and interoperability at the forefront. Embodiments of the present disclosure discuss a value schema system (VSS) that addresses these needs by introducing a comprehensive framework designed to: (1) standardize data attributes through the use of Common Data Schemas (CDS), (2) extend these standardized frameworks to include ownership and contextual information via Transactional Data Schemas (TDS), and (3) provide verifiable records of data attributes, ownership, and provenance through Data Certificates (DC). These limitations in conventional systems arise in part from the absence of unified schema definitions, inconsistent semantic models, and a lack of structural mechanisms to represent data ownership, sovereignty, or lineage.

The VSS redefines data cataloging and governance within digital trust ecosystems by ensuring clear data provenance, collaborative ownership, and governed data exchanges. It leverages a hierarchical compound of CDS, TDS, and DC to maintain data standards, provenance, ownership, traceability, and schema governance. This hierarchy may function as a protocol stack in which each layer reinforces definitions imposed by layers beneath it, ensuring consistent interpretation across heterogeneous systems.

Key functionalities of the VSS include: (1) an ownership lookup process that verifies data ownership and provenance; (2) a data lineage workflow that indexes new data elements and establishes their relationships to corresponding data owners; (3) a TDS registration workflow that maps specific data attributes to CDS (standardized schemas); and (4) a data logistic workflow that ensures that data structured according to standard dictionaries is validated, certified, and made accessible within the system. These workflows collectively ensure that event data records and other data artifacts are consistently interpreted and properly associated with the parties responsible for them.

Furthermore, the VSS incorporates Web Ontology Language (OWL) resources, standard vocabularies, and dictionaries to enhance semantic interoperability and precise data definitions. These elements enable automated reasoning and consistent attribute interpretation across systems that contribute data to, or retrieve data from, the VSS. The VSS's locator functionality integrates these components, ensuring consistent data definitions, reliable data retrieval, and clear ownership information while acknowledging regional data governance rules.

By addressing the limitations of traditional data systems, the VSS provides a robust foundation for governed data exchanges and collaborations within distributed digital ecosystems. This approach to data standardization, ownership, and interoperability supports advanced data governance and enables the consistent structuring and interpretation of event data across systems. The VSS forms the technological backbone of the digital trust ecosystem by enabling the registration and retrieval of globally unique resources, including CDS, TDS, and DCs. These resources are interconnected in a hierarchical structure that preserves data sovereignty, custody, and ownership.

An important aspect of the VSS is the creation of DCs, which are built upon the foundation of the TDS, which in turn relies on the CDS. The CDS provides a standardized framework for data attributes, ensuring consistent data definitions and interoperability. The TDS extends these definitions by incorporating ownership and contextual information specific to the entity that registers it. The DC consolidates this information, formally recognizing shared custody and ownership rights over particular data elements. Each DC provides a machine-verifiable link between an originating event data record, the schema governing its interpretation, and the parties asserting ownership or custodial roles.

A locator functionality of the VSS may integrate and reference these components. Instead of merely translating data models, the VSS resolves and binds data models to semantic definitions, storage locations, participant identities, and sovereignty metadata. Through the use of linked data resources encoding standardized vocabularies within standardized dictionaries, the system provides semantic definitions to CDS and, transitively, to TDS. With respect to data location, the VSS specifies where data can be retrieved, ensuring reliable and efficient access. With respect to identity, the VSS provides structured ownership and custodial information for system operators, data owners, data providers, and data custodians. With respect to sovereignty, the system incorporates regional identifiers within the hierarchical ID structure, specifying the region and country of origin for data and ensuring compliance with jurisdictional governance requirements.

The VSS also includes several key workflows to enhance its functionality. These workflows include a CDS registration workflow, in which a system operator registers CDS as interoperable standards in the VSS; a TDS registration workflow, in which a data provider selects a CDS to map as a TDS, ensuring that context-specific data attributes are aligned with standardized schema definitions; a data minting workflow, in which data elements stored within a data origin of a data provider are indexed to corresponding data owners; and a dataset-creation workflow, in which a data source associated with a TDS undergoes extract, transform, and load (ETL) procedures to ensure that data conforms to standardized dictionaries. This enables access to structured data (via APIs, data virtualization layers, or other interfaces) to create a schema-compliant dataset. Only certified data conforming to the TDS and CDS layers is made accessible within the system.

These components and functionalities work together to form a cohesive system that addresses limitations in traditional data catalogs and significantly enhances data governance, standardization, sovereignty, and interoperability. The VSS ensures that data attributes are accurately represented and consistently interpreted within distributed environments. With respect to interoperability, the VSS facilitates seamless data integration across diverse systems by enforcing consistent attribute definitions through CDS and TDS. With respect to data provenance, the VSS maintains a clear chain of provenance for data elements, enabling reliable interpretation and historical traceability. Data ownership refers to the legal rights and control over portions of data and determines who may access, use, modify, share, or delete that data. Ownership information maintained by the VSS provides a structural foundation for governed data exchanges based on mandatory identification of data owners. Data sovereignty refers to the principle that data is subject to the governance rules of the jurisdiction where it is collected, stored, or processed. As such, the VSS maintains sovereignty attributes through mandatory regional and country identifiers associated with custodians and providers, ensuring that data access and storage comply with applicable governance constraints.

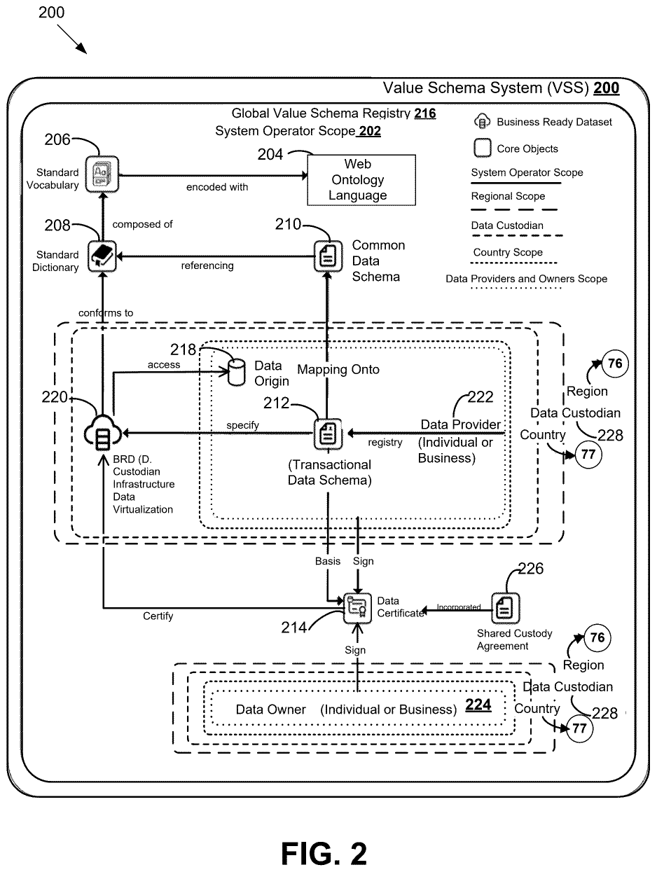

FIG. 2 illustrates a value schema system (VSS) 200 with core object associations, according to various embodiments of the present disclosure. The VSS 200 may incorporate the computing environment 10 of FIG. 1D. The VSS 200 may be a comprehensive framework designed to address the complexities of data standardization, ownership, sovereignty, and interoperability within digital trust ecosystems. The VSS 200 may redefine data management across distributed databases, ensuring clear data provenance, collaborative ownership, and governed data exchanges. The VSS 200 may include several core objects, each playing a crucial role in the system's functionality.

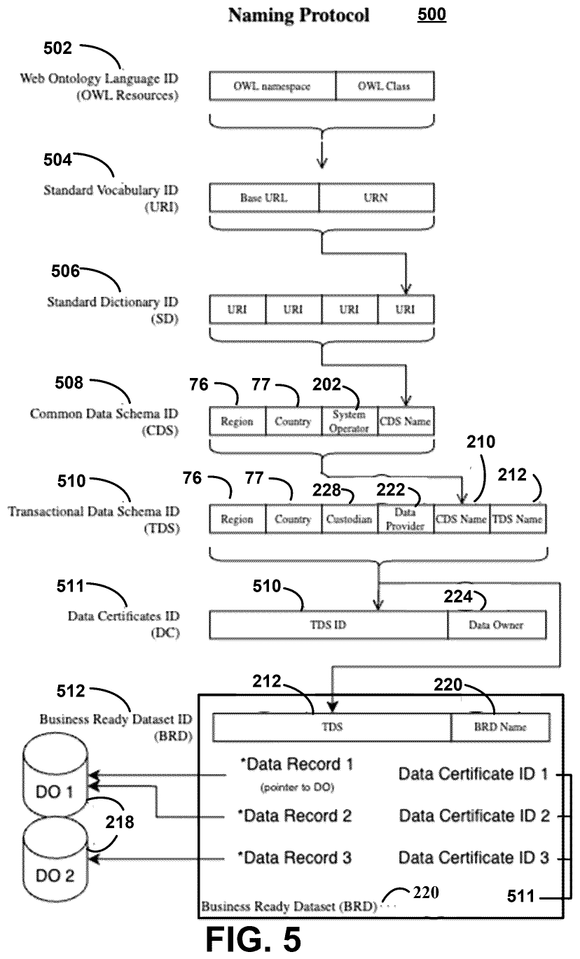

In various embodiments, the VSS 200 may include a system operator 202 that may be an entity responsible for defining a global interoperability naming protocol 500 (discussed in more detail with reference to FIG. 5) and establishing interoperability standards for data operations. The system operator 202 may manage and ensure the integrity and functionality of the overall VSS 200. The interoperability naming protocol 500 may define a global layer of semantic interoperability using core artifacts such as OWL resources 204, standard vocabularies 206, standard dictionaries 208, Common Data Schemas (CDS) 210, Transactional Data Schemas (TDS) 212, and Data Certificates (DC) 214. These artifacts may be stored within a global value schema registry module 216 in a cloud environment managed by the system operator 202. Data origins (DOs) 218 and schema-compliant datasets such as Business Ready Datasets (BRDs) 220 may be stored in accordance with data provider 222 and data custodian 228 specifications, respectively. The VSS 200 may also associate each custodian and provider with region identifiers 76 and country identifiers 77, which function as sovereignty attributes within the hierarchical naming protocol.

OWL resources 204 may be encoded using the Web Ontology Language and may encapsulate the standard vocabularies 206 and standard dictionaries 208 within the VSS 200. These resources may enable enhanced semantic interoperability by encoding and managing semantic relationships among data elements, ensuring that the meanings of data attributes are consistently understood across systems. This semantic enrichment may reduce ambiguities and enhance data integration across domains.

Standard vocabularies 206 may include curated collections of standardized terms and definitions used consistently throughout the VSS 200. These vocabularies may provide precise attribute definitions and promote consistent terminology among data providers 222 and data owners 224, thereby supporting semantic interoperability and reliable interpretation of data across the ecosystem.

Standard vocabularies 206 may be encoded in accordance with semantic web specifications for linked data and ontologies. Standard dictionaries 208 may be structured sets of attributes annotated with standard vocabularies 206, grouped around specific concepts or entities, and defined with functional dependencies between their attributes. By describing data attributes and their relational structure, the dictionaries 208 may ensure consistent definition and interoperability of data across systems.

Common Data Schemas (CDS) 210 may be frameworks designed to standardize data models within the VSS 200. Each CDS 210 may reference at least one standard dictionary 208 to ensure consistent attribute definitions across systems. CDS 210 may serve as foundational data-model layers used by all VSS participants and may support interoperability, sovereignty compliance, and schema governance. The system operator 202 may generate standard vocabularies 206, standard dictionaries 208, and CDSs 210.

A data provider 222 may be an individual or organization that generates, collects, or supplies data. Within the VSS 200, the data provider 222 may represent the provenance source for populating BRDs 220. Data providers 222 may maintain data in custody and construct ETL pipelines on behalf of data owners 224. They may also provide access to data and execute Shared Custody Agreements (SCAs) 226 with data owners 224. Their functionality may include registering TDS 212 and preparing data in accordance with TDS 212 definitions for incorporation into BRDs 220.

Transactional Data Schemas (TDS) 212 may be extensions of CDSs 210 that incorporate ownership and contextual information associated with a particular entity or organizational context. TDSs 212 may enable data providers 222 to tailor standardized CDS structures to suit specific contextual attributes while maintaining global interoperability. Each TDS 212 may map to at least one CDS 210 to ensure consistency and semantic coherence.

A Business Ready Dataset (BRD) 220, which may also function as a schema-compliant dataset, may be a collection of certified data organized according to a registered TDS 212. BRDs 220 may be structured in tabular or other data formats, with rows representing instances associated with ownership rights and columns representing attributes defined by TDS 212. BRDs 220 may ensure that data is accurate, interoperable, consistent with VSS 200 standards, and suitable for downstream analytic or operational processes.

A data custodian 228 may be an individual or organization responsible for the technical management and protection of BRDs 220 on behalf of data owners 224 and data providers 222. Custodians 228 may ensure the integrity, security, and accessibility of BRDs 220 and may enforce compliance with relevant standards and policies of the VSS 200.

In various embodiments, a TDS 212 may specify the schema structure for BRD 220 based on data models inherited from CDS 210. A BRD 220 may conform to the data model specified by a standard dictionary 208 referenced by its governing TDS 212. If a BRD 220 does not conform to its TDS 212, it may be considered invalid within the VSS 200.

Shared Custody Agreements (SCAs) 226 may formalize collaborative ownership arrangements. SCAs 226 may specify conditions under which data may be used, stored, or shared within the VSS 200.

Data Certificates (DCs) 214 may include verifiable records consolidating information from TDSs 212. Each DC 214 may formally recognize shared custody and ownership rights associated with specific data elements and may provide machine-verifiable provenance information. By incorporating ownership and contextual information from TDS 212, DCs 214 may attest to relationships between data owners 224 and data providers 222. SCAs 226 may be incorporated into DC 214 content, and each DC 214 may conform to the corresponding TDS 212.

A data owner 224 may be an individual or organization with legal rights and responsibilities for a specific portion of data. Data owners 224 may determine how their data is collected, stored, used, and shared. Data owners 224 may execute SCAs 226 with data providers 222 to generate DCs 214, which may authorize the inclusion of certified data into BRDs 220.

A Data Origin (DO) 218 may refer to records of raw data stored within a data provider's 222 cloud environment. DO 218 may serve as the foundational data source from which certified data is extracted and incorporated into BRDs 220. DO 218 may be used to fulfill BRD 220 data requirements, providing source material that becomes part of the structured, standardized datasets available within the VSS 200 after processing and certification. Data in DO 218 may be migrated into BRD 220 only when a DC 214 exists for the underlying relationship.

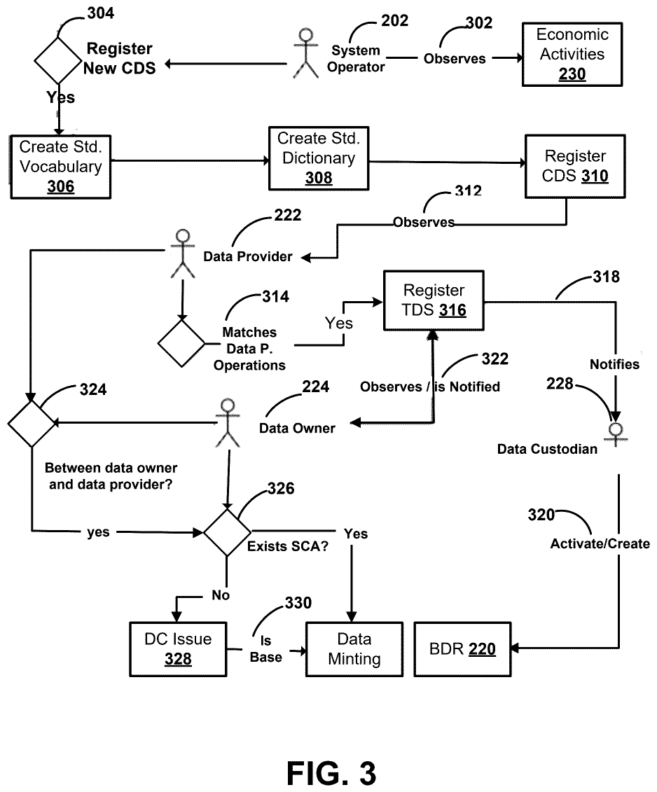

FIG. 3 illustrates a process 300 that describes how a system operator 202 may identify which CDSs 210 should be registered to support the global interoperability naming protocol 500. In various embodiments, the system operator 202 may monitor economic activities 230 or other data-generating activities (collectively referred to as events) to determine which portions of the ecosystem require standardized semantic modeling. Data providers 222 may then reference registered CDSs 210 for conformance and register new TDSs 212 that align with protocol specifications. Once a TDS 212 is available, data owners 224 may execute SCAs 226 with providers 222, and resulting relationships may be incorporated into DCs 214. Certified data associated with such relationships may be incorporated into BRDs 220 for further use in VSS 200 operations.

At step 302, the system operator 202 observes economic activities 230 or other events to determine schema requirements. Economic activities 230 may include actions performed on or through smart case 82 (FIGS. 1A-1D) or other computing devices within the ecosystem. The observed events may guide selection or creation of CDS 210 entries. Although economic activities are one example of events, other data-generating activities may also inform CDS 210 registration.

At decision step 304, the system operator 202 may determine whether to register a new CDS 210 based on observed events and an inclusion policy referred to as the Inclusion of New Common Data Schemas Policy (ICDSP). The ICDSP may define procedures for evaluating proposals for new CDS 210, ensuring compliance with standards, and conducting review or comment cycles among ecosystem participants. Approved CDS 210 entries may then be registered in the global value schema registry module 216.

Before registering a new CDS 210, the system operator 202 may define a standard vocabulary 206 at block 306 to ensure consistent meanings of terms across all standard dictionaries 208 referenced by that CDS 210. At block 308, the system operator 202 may establish one or more standard dictionaries 208 built from combinations of standard vocabularies 206, defining the conceptual model to be applied at CDS registration at block 310.

After the system operator 202 registers a CDS 210 at block 310, the CDS 210 may become available to data providers 222 as an interoperability standard. At step 312, the data provider 222 may observe the newly registered CDS 210. At decision block 314, the data provider 222 may determine whether the CDS 210 aligns with its operational context. If so, the data provider 222 may register a TDS 212 at step 316. At step 318, the data custodian 228 may be notified that a new TDS 212 has been registered, and at step 320, the data custodian 228 may create a BRD 220 within the custodian's cloud environment.

At step 322, a data owner 224 may observe or be notified of the registration of a new TDS 212. At decision block 324, the VSS 200 may verify whether the data owner 224 and the data provider 222 have a relationship (e.g., provider-consumer, employer-employee, or other association). If a relationship exists, the VSS 200 may determine at block 326 whether the parties have executed an SCA 226.

At step 328, data providers 222 and data owners 224 may establish a DC 214 based on a signed SCA 226, defining the data model and parties authorized to interact with the data under the corresponding relationship. The DC 214 may be stored in the data custodian's 228 environment, the system operator's 202 environment, or both, provided that the DC 214 conforms to its governing TDS 212.

The DC 214 may enable execution of a data-minting activity at step 330. Data minting may include inserting and migrating certified data from a data provider's 222 DO 218 into the BRD 220 maintained by the data custodian 228. The migrated data may conform to the BRD 220 schema specification and may then be available for VSS 200 operations.

In various embodiments, the VSS 200 may include multiple interconnected modules designed to perform functions that collectively ensure data standardization, ownership, sovereignty, and interoperability. These modules may work cohesively to support creation, registration, lookup, and management of CDS 210, TDS 212, DC 214, and BRD 220, ensuring that data flows through the system as a governed and semantically coherent asset.

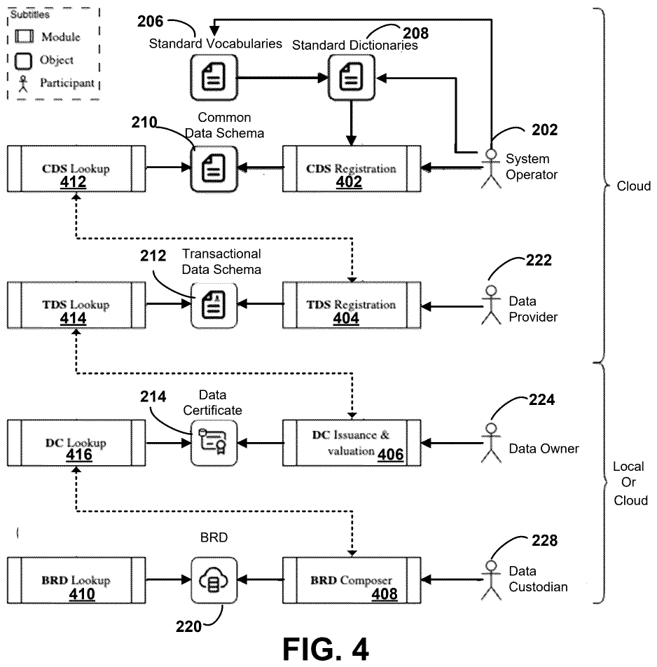

FIG. 4 illustrates relationships between participants, modules, and objects in the VSS 200. A system operator 202 may supply a standard dictionary 208 to a CDS registration module 402 to create a CDS 210. The CDS 210 can then be accessed by a data provider 222 using a TDS registration module 404 to create new TDSs 212. These TDSs 212 may be discoverable by data owners 224, who may utilize a data certificate issuer module 406 (labeled “DC Issuance & Valuation” in FIG. 4) to create and sign DCs 214. Data from certified relationships may be incorporated into a BRD 220, which functions as a schema-compliant dataset, through a BRD composer module 408. The resulting BRD 220 may then be made accessible to authorized participants via a BRD lookup module 410.

The global value schema registry module 216 of FIG. 2 may act as an identity provider within the VSS 200. The global value schema registry module 216 may generate globally unique identifiers (IDs) for core objects such as CDS 210, TDS 212, DCs 214, and BRDs 220 and ensure that each object can be distinctly recognized and referenced across the VSS 200. Inputs to the global value schema registry module 216 may include identifier-generation requests triggered by other modules, parameters specifying an object type (e.g., a CDS 210, a TDS 212, a DC 214, or a BRD 220), and metadata such as creator information, timestamps, and naming-protocol elements including region and country. The global value schema registry module 216 may output a unique global identifier that conforms to the global interoperability naming protocol 500, and in some embodiments may also output a confirmation receipt indicating that the identifier has been generated and stored.

In various embodiments, the CDS registration module 402 may allow the system operator 202 to register new CDSs 210 into the VSS 200, providing standardized frameworks for data attributes and definitions. Inputs to the CDS registration module 402 may include a CDS data model that defines a structural description of the CDS 210, including attributes and relationships, as well as a CDS name and metadata such as a schema name, version information, and references to associated standard dictionaries 208. The CDS registration module 402 may process these inputs, request a unique ID from the global value schema registry module 216, and output a registered CDS 210 stored in the VSS 200. In some embodiments, the CDS registration module 402 may also output a notification indicating that the CDS 210 is available for lookup and use by data providers 222.

In various embodiments, the VSS 200 may include a CDS lookup module 412 that enables data providers 222 and other participants to search for existing CDSs 210 so they can adopt standardized schemas. The CDS lookup module 412 may read CDSs 210 registered in the VSS 200. Inputs to the CDS lookup module 412 may include search criteria such as keywords, CDS names, or data-model characteristics, as well as filters based on categories, industry, region, or other metadata. The CDS lookup module 412 may output a list of matching CDSs 210, including details and access information. In some embodiments, the CDS lookup module 412 may also return schema descriptions that allow users to review the structure and definitions of a CDS 210.

In various embodiments, the TDS registration module 404 may allow data providers 222 to register TDSs 212 that extend CDSs 210 with ownership and contextual information specific to their operations. A data provider 222 may access the TDS registration module 404 to create new TDSs 212 in the VSS 200. The TDS registration module 404 may use the CDS lookup module 412 to retrieve registered CDSs 210 and provide a standardized base schema for the TDS. The TDS registration module 404 may receive, as inputs, a selected CDS 210, TDS customizations such as ownership details, context-specific attributes, and validity periods, and metadata such as data-provider information and TDS naming. The TDS registration module 404 may request a unique ID from the global value schema registry module 216, store the registered TDS 212 in the VSS 200, and output a confirmation or notification indicating that the TDS 212 is available for discovery by data owners 224.

In various embodiments, a TDS lookup module 414 may enable data owners 224 to find TDSs 212 that are relevant to their data, facilitating shared-custody agreements and data exchanges. The TDS lookup module 414 may read TDSs 212 registered in the VSS 200. Inputs to the TDS lookup module 414 may include search parameters such as TDS names, data-provider identifiers, or attribute requirements, as well as filters based on region, industry, or validity period. The TDS lookup module 414 may output a list of matching TDSs 212, including schema information that allows data owners 224 to understand the data requirements associated with each TDS 212.

In various embodiments, the data certificate issuer module 406 may facilitate the creation and issuance of DCs 214, formalizing shared custody agreements between data providers 222 and data owners 224. Data owners 224 may access the data certificate issuer module 406 to issue new DCs 214. The data certificate issuer module 406 may obtain TDSs 212 via the TDS lookup module 414 and may request unique IDs for new DCs 214 from the global value schema registry module 216. Inputs to the data certificate issuer module 406 may include a selected TDS 212, participant identifiers such as data-owner and data-provider IDs, and agreement terms describing the shared-custody arrangement. The data certificate issuer module 406 may output an issued DC 214, including a documented agreement with a unique ID and, in some embodiments, digital signatures from the parties involved, making the DC 214 accessible within the VSS 200.

In various embodiments, a DC lookup module 416 may allow participants to verify the existence and details of DCs 214, ensuring that data provenance and ownership are transparent. The DC lookup module 416 may read DCs 214 registered in the VSS 200. Inputs to the DC lookup module 416 may include search parameters such as a data-owner ID, a TDS ID, or a DC ID, as well as optional filters such as date ranges, data-provider IDs, region, country, or industry category. The DC lookup module 416 may output one or more DCs 214, including information about their contents and status. In some embodiments, the DC lookup module 416 may also output a verification status indicating the validity or current state of a DC 214, or a “not found” response if no matching record exists.

In various embodiments, a data custodian 228 may operate a BRD composer module 408. The BRD composer module 408 may be responsible for creating BRDs 220 and making certified data available, ensuring that such data has been extracted, transformed, and structured according to the applicable TDS 212. The data custodian 228 may access the BRD composer module 408 to create new BRDs 220 or to execute data-minting operations. The BRD composer module 408 may read TDSs 212 via the TDS lookup module 414 to obtain schema definitions, and may read DCs 214 via the DC lookup module 416 to determine which data is eligible to be minted. Inputs to the BRD composer module 408 may include verified DCs 214, raw data from data providers 222, and TDS specifications that describe how the data is to be structured. Outputs from the BRD composer module 408 may include a BRD 220 comprising a structured, certified dataset and, in some embodiments, a deployment confirmation indicating that the BRD 220 is accessible. The BRD composer module 408 may create new BRDs 220 or update existing BRDs 220 in the data custodian's 228 local infrastructure in accordance with TDS 212 specifications.

In various embodiments, the VSS 200 may include a BRD lookup module 410. The BRD lookup module 410 may enable authorized participants to access BRDs 220 for data operations, ensuring that structured datasets are discoverable and retrievable. The BRD lookup module 410 may read BRDs 220 and access data referenced by BRDs 220 in a DO 218. Inputs to the BRD lookup module 410 may include access credentials to authenticate participants, DC identifiers to determine access rights, and query parameters such as specific data requests, date ranges, or attribute filters. The BRD lookup module 410 may output requested data, such as a BRD 220 or selected data subsets, and may in some embodiments generate access logs documenting data retrieval activities for auditing purposes. While FIG. 4 illustrates one particular configuration of the VSS 200 with several interconnected modules, each performing specific functions related to data standardization, ownership, sovereignty, and interoperability, one of ordinary skill in the art in possession of this disclosure will recognize that alternative modules and interconnections may be implemented without departing from the scope of the present disclosure.

FIG. 5 illustrates the hierarchical structure of a naming protocol (NP) 500 for core objects within the VSS 200. The NP 500 may be used to generate globally unique identifiers for OWL resources 502, standard vocabulary identifiers 504, standard dictionary identifiers 506, Common Data Schema (CDS) identifiers 508, Transactional Data Schema (TDS) identifiers 510, Data Certificate (DC) identifiers 511, and Business Ready Dataset (BRD) identifiers 512. FIG. 5 specifically depicts an example BRD identifier 512 within a BRD 220 model and illustrates that data-record identifiers (e.g., pointers linking to records in a Data Origin (DO) 218) are not defined by the VSS 200. Identifiers used to designate DOs 218 may be independently assigned by a data custodian 228. For OWL resources 502 and standard vocabularies 504, certain naming conventions may be inherited from web standards such as the W3C “Uniform Resource Identifier (URI): Generic Syntax” (RFC 3986). The NP 500 establishes a consistent convention for generating unique identifiers for all core objects in the VSS 200.

The NP 500 may serve not only as a mechanism for uniquely identifying objects but also as a carrier of essential provenance, custodial, and sovereignty information. The NP 500 may ensure that data flows remain fully traceable from their point of origin at a data provider 222 to their storage or management by a data custodian 228, and that such flows comply with regional and jurisdictional governance constraints. By embedding regional and country identifiers into each object's identifier structure, the NP 500 may maintain data ownership, lineage, and sovereignty attributes throughout the data's lifecycle.

The NP 500 may define system locators for identifying core entities and governance attributes of the VSS 200. These system locators may include region identifiers 76, country identifiers 77, data provider identifiers 222, data owner identifiers 224, data custodian identifiers 228, and certificate identifiers such as DCs 214. Together, these locators may form a hierarchical identification mechanism that ensures provenance, ownership, and custody relationships are traceable and consistently encoded. As shown in FIG. 5, each VSS object has an identifier structure incorporating one or more of these locators.

The identifier hierarchy may begin with a region identifier 76, which is associated with the data custodian 228 responsible for safeguarding data within a defined geographic region. This association may ensure that any data managed by the data custodian 228 adheres to regional governance rules and regulatory constraints. Embedding the region identifier 76 within the NP 500 may therefore provide provenance information and jurisdictional context for data under custodian control.

Next, a country identifier 77 may be incorporated into the NP 500. The country identifier 77 may be associated with a data provider 222 and may specify the national jurisdiction under which the data provider operates. This ensures that activities of the data provider 222 are contextualized within the applicable country-level governance requirements. Embedding the country identifier 77 enhances traceability by linking the data provider's operations to a specific legal framework.

In some embodiments, certificate identifiers such as DC identifiers 511 may incorporate region and country locators for both the data custodian 228 and the data owner 224. This multi-layer locator structure may encode the full chain of custody associated with a certified relationship and may allow downstream systems to determine which entity controls the data, where it originated, and which governance rules apply. This hierarchical representation reinforces visibility into the data lifecycle and promotes reliable interpretation of custodial and ownership relationships.

A BRD 220 may be associated with multiple DCs 214. Because DC identifiers 511 themselves may incorporate TDS identifiers 510 and ownership locators, the BRD identifier 512 is not derived directly from DC identifiers 511. Instead, a BRD identifier 512 may be constructed as a combination of a TDS identifier 510 and a BRD-specific name. Within the BRD 220 object, pointers may link individual data records back to corresponding DOs 218, and references to associated DCs 214 may identify the relationships authorizing inclusion of such data.

In various embodiments, the OWL resource identifier 502 may include an external system URL associated with an ontology namespace defined by external ontology administrators, and a URN that names the resource within that namespace.

A standard vocabulary identifier 504 may include a system-operator URL representing a namespace defined by the system operator 202 and a URN that identifies a standard vocabulary 206. A standard dictionary identifier 506 may include a name derived from a combination of standard vocabularies 206 used to form the dictionary.

A CDS identifier 508 may include a region identifier 76, a country identifier 77, an identifier of the system operator 202 responsible for defining the schema, and a CDS name that may include or reference the standard dictionary identifier 506. The region identifier 76 may represent a geographic scope under which the CDS 210 is governed and may include an “all regions” indicator to signify that the CDS 210 is valid across all regions. Likewise, the country identifier 77 may represent national governance applicable to the schema and may include an “all countries” indicator. The CDS identifier 508 may therefore be traceable to the geographic and organizational context under which the CDS 210 was created.

A TDS identifier 510 may extend a CDS identifier 508 by incorporating a region identifier 76 associated with the data custodian 228, a country identifier 77 associated with the data provider 222, an identifier of the data custodian 228, an identifier of the data provider 222, the CDS identifier 508, and optionally a TDS name. This structure may allow differentiation of TDSs 212 across organizational contexts while embedding provenance and sovereignty attributes associated with the data custodian 228 and data provider 222.

A DC identifier 511 may include the TDS identifier 510, as described above, as well as an identifier for the data owner 224. Because a DC 214 must encode complete ownership and custodial relationships for a certified dataset, the DC identifier 511 may incorporate both region and country locators, along with the identifiers of the participants to the shared custody agreement. This multi-element hierarchy may allow each DC 214 to be uniquely traced to its originating entities and associated jurisdictional rules.

A BRD identifier 512 may incorporate a TDS identifier 510 and a BRD-specific name. The BRD identifier 512 may therefore extend the hierarchical TDS identifier 510 by including a unique BRD name. This approach ensures that BRDs 220 remain distinct within the VSS 200 while preserving the provenance, sovereignty, and custodial information encoded in the underlying TDS identifier 510.

In some cases, the present techniques may be implemented with those described in the following, each of which is hereby incorporated by reference: U.S. patent application Ser. No. 17/535,413 (having docket no. 043638-0564878), titled METHOD OF SCORING AND VALUING DATA FOR EXCHANGE; U.S. patent application Ser. No. 18/514,536 (having docket no. 043638-0577902), titled CROSS-DEVICE DATA DISTRIBUTION WITH MODULAR ARCHITECTURE; U.S. Pat. App. 63/637,144 (having docket no. 043638-0577054), titled METHOD OF SCORING AND VALUING COMBINATIONS OF DATA FOR EXCHANGE; and U.S. patent application Ser. No. 17/959,842 (having docket no. 043638-0458797), titled APPLICATION DATA EXCHANGE SYSTEM.

In some embodiments, the VSS 200 may employ one or more machine-learning models to improve the accuracy or efficiency of schema selection. For example, event data may be analyzed using classifiers, embedding similarity models, or statistical inference engines to determine which CDS 210 or TDS 212 best corresponds to the attributes present in an incoming event data record. Such models may operate on embeddings derived from standard vocabularies 206, standard dictionaries 208, or historical mappings, thereby enabling the VSS 200 to dynamically determine schema applicability based on contextual cues, semantic similarity, or learned correlations.

In various embodiments, the VSS 200 may support offline or intermittent-connectivity operation. For example, a smart case 82 or other computing device may locally buffer event data records, attestations, or DC-related information until network connectivity becomes available. Once connectivity is reestablished, the device may transmit the buffered data to the VSS 200, where it may be validated, associated with existing TDS 212 or DC 214 structures, and incorporated into a BRD 220. This embodiment may improve reliability in scenarios where continuous network availability is not guaranteed.

In some embodiments, one or more modules of the VSS 200 described herein (e.g., CDS registration module 402, TDS registration module 404, DC issuer module 406, BRD composer module 408, BRD lookup module 410) may be implemented using distributed microservices, hardware accelerators, state machines, or containerized workloads across a cloud infrastructure. Distributed execution may allow modules to scale independently, maintain redundancy, and support high-throughput environments in which event data records and schema operations occur concurrently across multiple participants.

In certain embodiments, the VSS 200 may include an application programming interface (API) layer that exposes one or more endpoints for transmitting event data records, performing schema lookup, registering new schemas, issuing DCs 214, or retrieving BRDs 220. Such APIs may be implemented using protocols such as REST, gRPC, message queues, or publish-subscribe architectures. API versioning may be used to preserve backward compatibility for participants relying on earlier VSS 200 specifications.

In some embodiments, alternative data structures may be employed for storing certified data. For example, a BRD 220 may be implemented as a graph-based dataset, a columnar analytical structure, a linked set of certificate-referenced data nodes, or a key-value store that maps TDS 212 attributes to associated event data. These alternatives may be used alone or in combination, allowing the data custodian 228 to select storage structures that optimize for latency, throughput, or analytical workflows while remaining compliant with the TDS 212 specification.

In some embodiments, additional sovereignty attributes beyond region identifiers 76 and country identifiers 77 may be embedded into object identifiers generated by the naming protocol 500. For example, subregion identifiers, municipality identifiers, sector-specific jurisdictional identifiers, or regulatory-domain identifiers may be included to support finer-grained compliance requirements. Incorporation of additional locator fields may allow datasets, schemas, or certificates to reflect more precise governance constraints.

In some embodiments, the VSS 200 may provide optional security features such as tamper-resistant storage of DCs 214, cryptographic hashing of event data associated with TDS 212 records, or integrity attestation using secure enclaves present on smart case 82 or other devices. These features may help ensure that event data incorporated into BRDs 220 is authentic, unaltered, and traceable to authorized participants. In some embodiments, zero-knowledge proof techniques or selective-disclosure mechanisms may be used to permit validation of attributes without revealing unnecessary details.

In various embodiments, the VSS 200 may allow dynamic extension or modification of CDS 210, TDS 212, DC 214, or BRD 220 structures as the needs of a digital trust ecosystem evolve. Schema inheritance, modular composition, or version-based evolution may allow schemas to be expanded or retired while maintaining backward compatibility with existing data. These mechanisms may support stable long-term interoperability across a large and diverse population of data providers 222, data owners 224, and data custodians 228.

In some embodiments, the VSS 200 may incorporate event lineage tracking, whereby each event data record is associated with metadata regarding its source device, time of creation, schema version, and certificate linkage. This lineage information may enable auditability, debugging of schema evolution issues, or reconstruction of data transformations performed by downstream systems. In certain embodiments, lineage may be encoded directly within BRD 220 structures or stored as auxiliary provenance records.

In some embodiments, the techniques described herein may be applied to a variety of domains, including but not limited to supply-chain systems, identity systems, regulatory-compliance workflows, environmental-data networks, or distributed AI model training pipelines. The modularity of the VSS 200 architecture may allow new entities, schemas, and governance layers to be introduced without altering the underlying identification, provenance, or interoperability mechanisms.

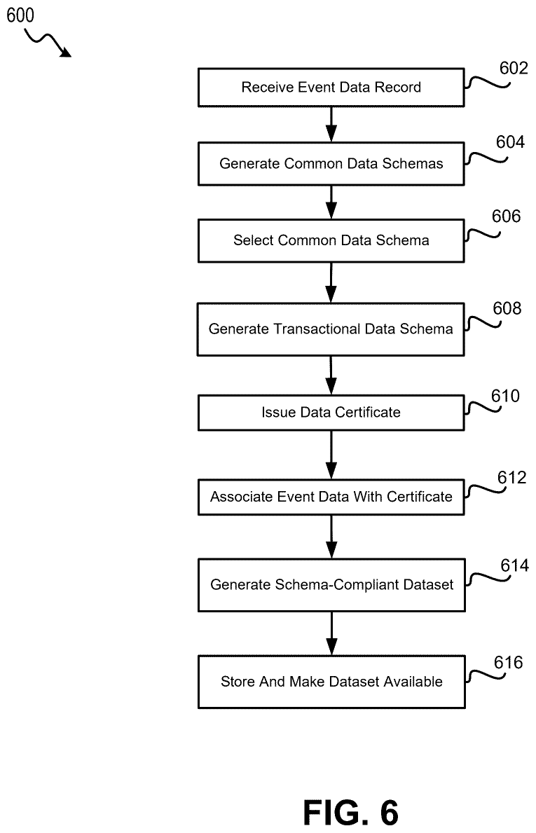

FIG. 6 illustrates an embodiment of a method 600 for generating standardized and certified datasets within the Value Schema System (VSS) 200, consistent with various embodiments of the present disclosure. While a particular sequence of operations is illustrated, one of ordinary skill in the art will recognize that certain steps may be omitted, combined, augmented, or reordered without departing from the scope of the present disclosure. The method 600 provides technological improvements to computer systems by enabling automated schema selection, certified provenance encoding, and generation of interoperable schema-compliant datasets.

The method 600 may begin at block 602, where an event data record is received. In various embodiments, at block 602, the VSS 200 may receive an event data record from one or more data sources, such as computing devices operating within a distributed environment. The event data record may include attribute values or contextual metadata captured at or near the time of occurrence, which the VSS 200 may ingest through an application programming interface, message bus, or other communication mechanism.

The method 600 proceeds to block 604, where common data schemas are generated. In various embodiments, at block 604, the VSS 200 may generate or update a plurality of common data schemas (CDSs) 210 based on the structure, content, and semantic characteristics of the received event data record. The CDSs 210 may reference one or more standard vocabularies 206 and one or more standard dictionaries 208 to ensure consistent attribute definitions and semantic interoperability across disparate systems.

The method 600 proceeds to block 606, where a first common data schema is selected.

In various embodiments, at block 606, the VSS 200 may evaluate the plurality of CDSs 210 and select a first CDS 210 that satisfies a CDS-selection condition. The selection condition may be based on attribute compatibility, semantic alignment, or required contextual fields, and may be determined using the CDS lookup module 412.

The method 600 proceeds to block 608, where a transactional data schema is generated.

In various embodiments, at block 608, the VSS 200 may generate a transactional data schema (TDS) 212 mapped to the first CDS 210. The TDS 212 may incorporate additional contextual or ownership information while extending the attribute definitions established by the first CDS 210.

The method 600 proceeds to block 610, where a data certificate is issued. In various embodiments, at block 610, the VSS 200 may issue a data certificate (DC) 214 based on the TDS 212. The data certificate 214 may identify a data owner 224, include a globally unique identifier generated by the global value schema registry module 216, and encode custody or provenance attributes associated with the event data.

The method 600 proceeds to block 612, where the event data record is associated with the data certificate. In various embodiments, at block 612, the VSS 200 may validate the event data record against the TDS 212 and associate the event data record with the data certificate 214 to ensure proper provenance and attribution.

The method 600 proceeds to block 614, where a schema-compliant dataset is generated.

In various embodiments, at block 614, the VSS 200 may generate a schema-compliant dataset, such as a BRD 220 or equivalent structured dataset, comprising a representation of the event data record formatted according to the TDS 212. This may include performing extract-transform-load (ETL) operations to align the event data with attribute constraints and dictionary definitions.

The method 600 proceeds to block 616, where the schema-compliant dataset is stored and made available. In various embodiments, at block 616, the VSS 200 may store the schema-compliant dataset in a data store accessible to downstream computing systems. The VSS 200 may expose application programming interfaces or secure retrieval mechanisms through which one or more computing systems may access the dataset for subsequent operations, ensuring interoperability and traceability across domains.

Although particular modules, flows, and interactions have been described with reference to FIGS. 1A-5, it should be understood that the arrangement, order, and implementation of such components may vary across embodiments. Operations may be performed in parallel or in different sequences, and modules may be combined or subdivided. Optional or alternative components may be incorporated into the VSS 200 without departing from the scope of the present disclosure. Examples, lists, and workflows are intended to be illustrative and not limiting.

Thus, the techniques described herein disclose a value schema system (VSS) 200 that provides a unified, machine-enforceable framework for data standardization, ownership, sovereignty, provenance, and interoperability within distributed computing environments. The VSS 200 improves computer system functionality by enabling automated schema selection, structured data certification, and consistent multi-party data governance using hierarchical identifiers, extensible dictionaries, transactional schemas, and verifiable certificates. When used in conjunction with a smart case 82 or other edge devices capable of generating authenticated event data records, the system provides a hardware-rooted mechanism for data integrity, secure provenance capture, and privacy preservation. These improvements represent technological solutions to long-standing challenges in heterogeneous data modeling, cross-domain interoperability, and distributed data management, and may significantly enhance the reliability, auditability, and expressive power of computer systems operating within complex digital ecosystems.

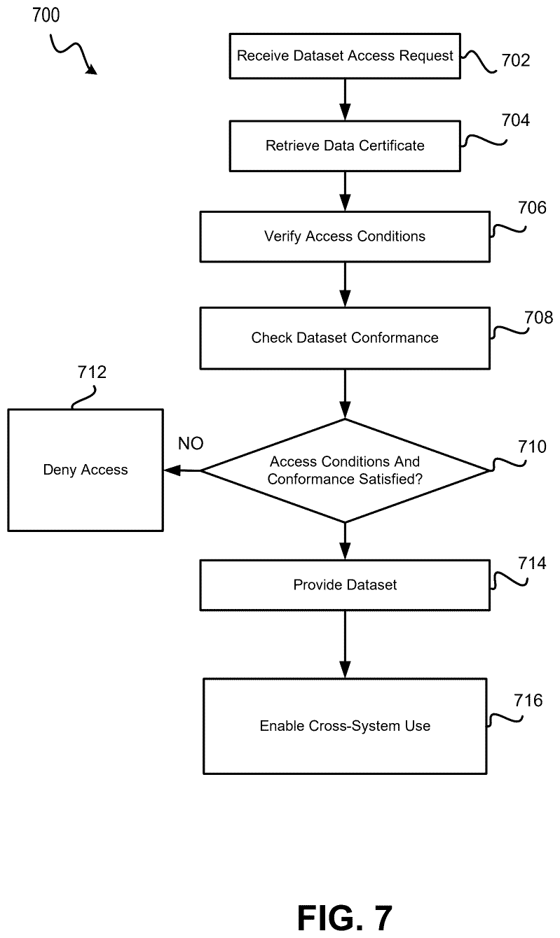

FIG. 7 illustrates an embodiment of a method 700 for governing access to schema-compliant datasets within the VSS 200 and enabling cross-system use of certified data, consistent with various embodiments of the present disclosure. While a particular sequence of operations is shown, one of ordinary skill in the art will recognize that certain steps may be omitted, combined, reordered, or supplemented without departing from the scope of the present disclosure. The method 700 improves computer system security and interoperability by enforcing ownership-based access conditions and schema-level validation before providing data to requesting systems.

The method 700 may begin at block 702, where a request to access a dataset is received.

In various embodiments, at block 702, the VSS 200 may receive a request from a computing system to access a schema-compliant dataset stored in a data store. The request may identify the dataset by a dataset identifier referencing a BRD 220 or equivalent structured dataset.

The method 700 proceeds to block 704, where a data certificate is retrieved. In various embodiments, at block 704, the VSS 200 may retrieve a data certificate 214 associated with the dataset identifier. The data certificate 214 may reference the transactional data schema (TDS) 212 governing the dataset's attribute definitions and constraints.

The method 700 proceeds to block 706, where access conditions are verified. In various embodiments, at block 706, the VSS 200 may verify, based on the data certificate 214, that the requesting computing system satisfies one or more access conditions established by a data owner 224. Such access conditions may include authorization requirements, participant identifiers, or governance metadata embedded within the data certificate.

The method 700 proceeds to block 708, where dataset conformance is evaluated. In various embodiments, at block 708, the VSS 200 may determine whether the schema-compliant dataset conforms to attribute constraints defined by the corresponding TDS 212. Conformance checks may include verifying field types, attribute cardinality, relational constraints, or dictionary-derived semantic definitions.

The method 700 proceeds to decision block 710, where it is determined whether access conditions are satisfied and conformance is confirmed. If the access conditions are not satisfied or the dataset fails conformance checks, the method 700 may proceed to block 712, where access is denied. In various embodiments, at block 712, the VSS 200 may generate an error response or audit entry indicating failure to satisfy required conditions.

If both the access conditions and conformance checks are satisfied at decision block 710, the method 700 proceeds to block 714, where at least a portion of the dataset is provided. In various embodiments, at block 714, the VSS 200 may provide, through an interface of the VSS 200, a portion or all of the schema-compliant dataset to the requesting computing system, enabling authorized use of the certified data.

The method 700 proceeds to block 716, where cross-system use is enabled. In various embodiments, at block 716, the VSS 200 may enable cross-system use of the dataset by permitting the requesting computing system to reference the dataset identifier and the associated data certificate 214 in subsequent requests submitted by additional computing systems. This may allow downstream systems to inherit provenance, access rules, and schema-governed semantics associated with the dataset, ensuring consistent and interoperable data operations across systems.

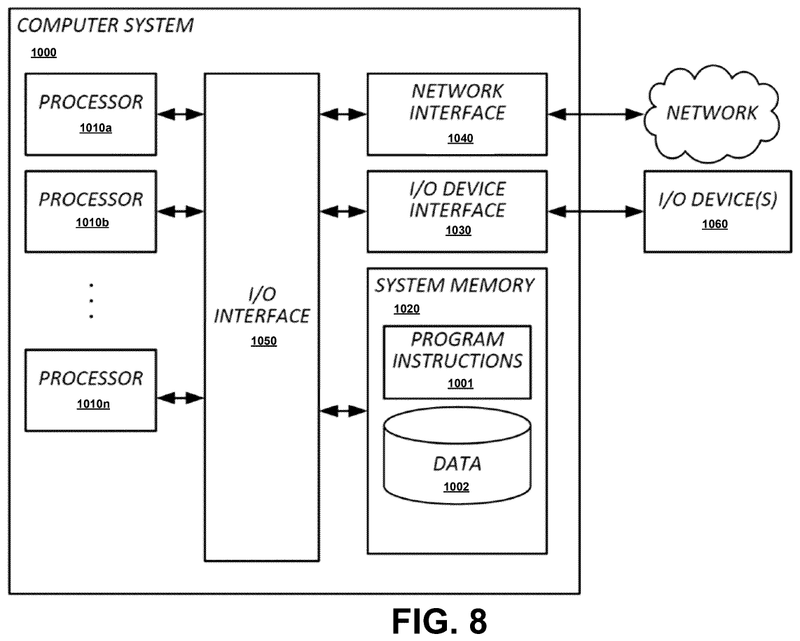

FIG. 8 is a diagram that illustrates an exemplary computing system 1000 in accordance with embodiments of the present technique. A single computing device is shown, but some embodiments of a computer system may include multiple computing devices that communicate over a network, for instance in the course of collectively executing various parts of a distributed application. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1001 or data 1002. Program instructions 1001 may be executable by a processor (e.g., one or more of processors 1010a-1010n) to implement one or more embodiments of the present techniques. Instructions 1001 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following first set of enumerated embodiments:
Clause 1. A method comprising: receiving, by a Value Schema System (VSS), an event data record generated by a mobile computing case having an independent processor, the event data record including information characterizing an event performed by a user authenticated through the mobile computing case; generating, by the VSS and based on observed data-generating activities including the event data record, a plurality of common data schemas, each common data schema defining standardized data attributes according to one or more standard vocabularies and one or more standard dictionaries; selecting, by the VSS, a first common data schema of the plurality of common data schemas in response to the first common data schema satisfying a common data schema condition; generating, by the VSS, a transactional data schema based on the first common data schema and in accordance with a transactional data schema condition; issuing, by the VSS, a data certificate conforming to the transactional data schema and identifying a data owner associated with the event data record; associating, by the VSS, the event data record with the data certificate; generating, by the VSS, a schema-compliant dataset comprising a pointer to a storage location of the event data record, a data certificate identifier of the data certificate, and a transactional data schema identifier of the transactional data schema; and storing, by the VSS, the schema-compliant dataset in a data store and making the schema-compliant dataset available for access by one or more computing systems.
Clause 2. The method of clause 1, wherein the mobile computing case comprises an independent processor, a biometric sensor configured to authenticate the user, a touchscreen display disposed on a rear surface of the case configured to receive contextual input, and a near-field communication interface or other short-range interface operative to convey the event data record to the VSS.
Clause 3. The method of clause 1, wherein the mobile computing case operates independently of an operating system of a mobile computing device received in the case, and wherein the event data record is cryptographically signed by the independent processor before being transmitted to the VSS.
Clause 4. The method of clause 1, wherein the mobile computing case further comprises an orientation sensor configured to detect placement of the case in a screen-down orientation and, in response to the detection, to instruct the mobile computing device to disable one or more sensors of the mobile computing device while continuing to permit generation of the event data record.
Clause 5. The method of clause 1, wherein selecting the first common data schema comprises determining that the first common data schema satisfies a semantic-interoperability requirement defined by the one or more standard vocabularies and the one or more standard dictionaries.
Clause 6. The method of clause 1, wherein generating the transactional data schema comprises incorporating provenance attributes derived from the event data record, including a device identifier of the mobile computing case or a region identifier associated with a data custodian.
Clause 7. The method of clause 1, wherein issuing the data certificate further comprises embedding a reference to the transactional data schema and a reference to a shared-custody arrangement between a data provider and the data owner.
Clause 8. The method of clause 1, wherein associating the event data record with the data certificate comprises performing a schema-validation operation confirming that the event data record conforms to attribute definitions of the transactional data schema before permitting use of the event data record in the schema-compliant dataset.
Clause 9. The method of clause 1, wherein generating the schema-compliant dataset comprises executing extract, transform, and load operations that normalize, map, and restructure the event data record according to attribute constraints defined by the transactional data schema and the first common data schema.
Clause 10. A method comprising: receiving, by a Value Schema System (VSS), an event data record generated by one or more data sources; generating, by the VSS based on the event data record, a plurality of common data schemas, each common data schema referencing one or more standard vocabularies and one or more standard dictionaries; selecting, by the VSS, a first common data schema of the plurality of common data schemas in response to the first common data schema satisfying a common data schema condition; generating, by the VSS, a transactional data schema mapped to the first common data schema; issuing, by the VSS, a data certificate based on the transactional data schema and identifying a data owner; associating, by the VSS, the event data record with the data certificate; generating, by the VSS, a schema-compliant dataset comprising a structured representation of the event data record according to the transactional data schema; and storing, by the VSS, the schema-compliant dataset in a data store and making the schema-compliant dataset available for access by one or more computing systems.
Clause 11. The method of clause 10, wherein the event data record is generated by a mobile computing case having an independent processor.
Clause 12. The method of clause 10, wherein receiving the event data record comprises ingesting the event data record through an application programming interface of the VSS.
Clause 13. The method of clause 10, wherein receiving the event data record comprises retrieving an event log maintained by a data provider.
Clause 14. The method of clause 10, further comprising generating, by the VSS, a globally unique identifier for the common data schema, the transactional data schema, and the data certificate according to a hierarchical naming protocol embedding region and country information.
Clause 15. The method of clause 10, wherein issuing the data certificate comprises verifying a shared-custody arrangement between a data owner and a data provider.
Clause 16. The method of clause 10, wherein associating the event data record with the data certificate comprises performing a data-migration process that transfers certified data from a data origin to the schema-compliant dataset according to the transactional data schema.
Clause 17. The method of clause 10, wherein the VSS comprises a common data schema registration module, a transactional data schema registration module, a data certificate issuance module, a dataset generation module, and a dataset lookup module, and wherein the method further comprises invoking at least one of the modules to perform the generating, issuing, or associating operations.
Clause 18. The method of clause 10, further comprising generating, by the VSS, the one or more standard vocabularies and the one or more standard dictionaries referenced by the common data schemas.
Clause 19. The method of clause 10, further comprising verifying, by the VSS, conformity of the event data record to the transactional data schema before incorporating the event data record into the schema-compliant dataset.
Clause 20. A method comprising: receiving, by a Value Schema System (VSS), a request from a computing system to access a schema-compliant dataset stored in a data store, the request identifying a dataset identifier; retrieving, by the VSS, a data certificate associated with the dataset identifier, the data certificate referencing a transactional data schema defining attribute constraints for data within the schema-compliant dataset; verifying, by the VSS and based on the data certificate, that the computing system satisfies one or more access conditions associated with a data owner identified in the data certificate; determining, by the VSS and based on the transactional data schema, that the schema-compliant dataset conforms to attribute constraints defined by the transactional data schema; in response to verifying the one or more access conditions and determining that the schema-compliant dataset conforms to the transactional data schema, providing, by the VSS, at least a portion of the schema-compliant dataset to the computing system through an interface of the VSS; and enabling, by the VSS, cross-system use of the schema-compliant dataset by permitting the computing system to reference the dataset identifier and associated data certificate in subsequent requests submitted by additional computing systems.

What is claimed is:

1. A method comprising:
receiving, by a Value Schema System (VSS), an event data record generated by a mobile computing case having an independent processor, the event data record including information characterizing an event performed by a user authenticated through the mobile computing case;
generating, by the VSS and based on observed data-generating activities including the event data record, a plurality of common data schemas, each common data schema defining standardized data attributes according to one or more standard vocabularies and one or more standard dictionaries;
selecting, by the VSS, a first common data schema of the plurality of common data schemas in response to the first common data schema satisfying a common data schema condition;
generating, by the VSS, a transactional data schema based on the first common data schema and in accordance with a transactional data schema condition;
issuing, by the VSS, a data certificate conforming to the transactional data schema and identifying a data owner associated with the event data record;
associating, by the VSS, the event data record with the data certificate;
generating, by the VSS, a schema-compliant dataset comprising a pointer to a storage location of the event data record, a data certificate identifier of the data certificate, and a transactional data schema identifier of the transactional data schema; and
storing, by the VSS, the schema-compliant dataset in a data store and making the schema-compliant dataset available for access by one or more computing systems.

2. The method of claim 1, wherein the mobile computing case comprises the independent processor, a biometric sensor configured to authenticate the user, a touchscreen display disposed on a rear surface of the mobile computing case configured to receive contextual input, and a near-field communication interface or other short-range interface operative to convey the event data record to the VSS.

3. The method of claim 1, wherein the mobile computing case operates independently of an operating system of a mobile computing device received in the mobile computing case, and wherein the event data record is cryptographically signed by the independent processor before being transmitted to the VSS.

4. The method of claim 3, wherein the mobile computing case further comprises an orientation sensor configured to detect placement of the mobile computing case in a screen-down orientation and, in response to the detection, to instruct the mobile computing device to disable one or more sensors of the mobile computing device while continuing to permit generation of the event data record.

5. The method of claim 1, wherein selecting the first common data schema comprises determining that the first common data schema satisfies a semantic-interoperability requirement defined by the one or more standard vocabularies and the one or more standard dictionaries.

6. The method of claim 1, wherein generating the transactional data schema comprises incorporating provenance attributes derived from the event data record, including a device identifier of the mobile computing case or a region identifier associated with a data custodian.

7. The method of claim 1, wherein issuing the data certificate further comprises embedding a reference to the transactional data schema and a reference to a shared-custody arrangement between a data provider and the data owner.

8. The method of claim 1, wherein associating the event data record with the data certificate comprises performing a schema-validation operation confirming that the event data record conforms to attribute definitions of the transactional data schema before permitting use of the event data record in the schema-compliant dataset.

9. The method of claim 1, wherein generating the schema-compliant dataset comprises executing extract, transform, and load operations that normalize, map, and restructure the event data record according to attribute constraints defined by the transactional data schema and the first common data schema.

10. A method comprising:
receiving, by a Value Schema System (VSS), an event data record generated by one or more data sources;
generating, by the VSS based on the event data record, a plurality of common data schemas, each common data schema referencing one or more standard vocabularies and one or more standard dictionaries;
selecting, by the VSS, a first common data schema of the plurality of common data schemas in response to the first common data schema satisfying a common data schema condition;
generating, by the VSS, a transactional data schema mapped to the first common data schema;
issuing, by the VSS, a data certificate based on the transactional data schema and identifying a data owner;
associating, by the VSS, the event data record with the data certificate;
generating, by the VSS, a schema-compliant dataset comprising a structured representation of the event data record according to the transactional data schema; and
storing, by the VSS, the schema-compliant dataset in a data store and making the schema-compliant dataset available for access by one or more computing systems.

11. The method of claim 10, wherein the event data record is generated by a mobile computing case having an independent processor.

12. The method of claim 10, wherein receiving the event data record comprises ingesting the event data record through an application programming interface of the VSS.

13. The method of claim 10, wherein receiving the event data record comprises retrieving an event log maintained by a data provider.

14. The method of claim 10, further comprising generating, by the VSS, a globally unique identifier for the first common data schema, the transactional data schema, and the data certificate according to a hierarchical naming protocol embedding region and country information.

15. The method of claim 10, wherein issuing the data certificate comprises verifying a shared-custody arrangement between a data owner and a data provider.

16. The method of claim 10, wherein associating the event data record with the data certificate comprises performing a data-migration process that transfers certified data from a data origin to the schema-compliant dataset according to the transactional data schema.

17. The method of claim 10, wherein the VSS comprises a common data schema registration module, a transactional data schema registration module, a data certificate issuance module, a dataset generation module, and a dataset lookup module, and wherein the method further comprises invoking at least one of the modules to perform the generating, issuing, or associating operations.

18. The method of claim 10, further comprising generating, by the VSS, the one or more standard vocabularies and the one or more standard dictionaries referenced by the plurality of common data schemas.

19. The method of claim 10, further comprising verifying, by the VSS, conformity of the event data record to the transactional data schema before incorporating the event data record into the schema-compliant dataset.

20. A method comprising:
receiving, by a Value Schema System (VSS), a request from a computing system to access a schema-compliant dataset stored in a data store, the request identifying a dataset identifier;
retrieving, by the VSS, a data certificate associated with the dataset identifier, the data certificate referencing a transactional data schema defining attribute constraints for data within the schema-compliant dataset;
verifying, by the VSS and based on the data certificate, that the computing system satisfies one or more access conditions associated with a data owner identified in the data certificate;
determining, by the VSS and based on the transactional data schema, that the schema-compliant dataset conforms to attribute constraints defined by the transactional data schema;
in response to verifying the one or more access conditions and determining that the schema-compliant dataset conforms to the transactional data schema, providing, by the VSS, at least a portion of the schema-compliant dataset to the computing system through an interface of the VSS; and
enabling, by the VSS, cross-system use of the schema-compliant dataset by permitting the computing system to reference the dataset identifier and associated data certificate in subsequent requests submitted by additional computing systems.
